(19) United States
(12) Patent Application Publication
(10) Pub. No.: US 2004/0108666 A1
(43) Pub. Date: Jun. 10, 2004

(54) Nestable container

(75) Inventor: Robert W. Lauer, Winchester, VA (US)

Correspondence Address: FOLEY AND LARDNER, SUITE 500, 3000 K STREET NW, WASHINGTON, DC, 20007, US

(73) Assignee: Rubbermaid Commercial Products LLC

(21) Appl. No.: 10/632,144

(22) Filed: Aug. 1, 2003

Related U.S. Application Data
(60) Provisional application No. 60/400,056, filed on Aug. 2, 2002.

(51) Int. Cl. B62B 1/00

(52) U.S. Cl. 280/33.998; 280/47.26

(57) ABSTRACT

A wheeled container having an axle and a first wheel connected to the axle and container having a bottom portion. A slot is disposed in the bottom portion of the wheeled container and receives the axle. The first slot has an inboard end in which the first wheel is positioned for nesting of the wheeled container in another container, and an outboard end, in which the first wheel is deployed for use, and space therebetween to permit movement of the axle along the first slot. The first slot is configured to direct the axle toward the outboard end when the first wheel is placed on a ground surface.

### RELATED APPLICATIONS

The present application claims priority to U.S. provisional application serial No. 60/400,056, filed on Aug. 2, 2002, the contents of which is incorporated herein in its entirety.

### BACKGROUND OF THE INVENTION

1. Field of the Invention

The present invention relates to a container and, more particularly, to a wheeled container that can be nested in another container.

2. Description of Related Art

Wheeled containers are often used for holding waste. Such containers often have a capacity greater than 30 gallons and can be significantly larger and have a capacity of, for example, 64 gallons. Containers with such large capacity can be difficult to move when fully or even partially loaded. Consequently, the containers are provided with wheels to make the containers easier to move. The wheels often are attached to an axle that in turn is attached to the container.

For purposes of packaging and shipping a large number of containers, it is preferable to be able to nest the containers within one another. The space required to ship multiple containers can thus be reduced.

Some containers are designed to be shipped with the wheels and axle attached to the container body, i.e., fully assembled. In such containers, the wheels may be positioned inboard, i.e., inward toward the center of the container, so the wheels do not inhibit nesting of the containers. This positioning of the wheels, however, can result in less than preferred stability of the container during use.

Some containers are designed to ship with the wheels and axle unattached to the container body, i.e., unassembled. The wheels and axle can be placed inside the corresponding container body and multiple container bodies can be nested for shipment. The nested containers are then placed on shipping pallets, banded to the pallets, and sometimes wrapped in cellophane. Because the unattached wheels and axle will not inhibit nesting, the container can be designed such that the wheels will be attached to the container in an ‘outboard’ position for use, thus better positioning the wheels relative to the container's center of gravity and improving stability. Stability can be an important feature for the user, as it makes it easier to control the container when it is being wheeled, and when placed at curbside in high winds. Unassembled shipping may be acceptable to commercial users (e.g., waste haulers), but they do suffer a cost in the labor required to assemble the wheels and axles to the containers. Additionally, the parts may be lost. This unassembled style of container often is not acceptable for retailers selling to household consumers, due to, for example, (a) the possibility of lost parts and (b) the difficulty a consumer experiences in transporting a large container from the store aisle, through the store, and to their automobile.

Some conventional containers are designed to permit movement of the wheels and axle between an inboard position and an outboard position. When the wheels are in the inboard position, the containers can be nested for shipment. After shipping, the wheels can be moved to the outboard position for use. These containers, however, require the user to reach down and move the wheels and axle into the outboard position after the container is un-nested.

### SUMMARY OF THE INVENTION

An aspect of the present invention relates to a wheeled container including an axle, a first wheel connected to the axle, a container having a bottom portion, and a first slot disposed in the bottom portion of the wheeled container and that receives the axle. The first slot has an inboard end, in which the first wheel is positioned for nesting of the wheeled container in another container, and an outboard end, in which the first wheel is deployed for use, and space therebetween to permit movement of the axle along the first slot. The first slot is configured to direct the axle toward the outboard end when the first wheel is placed on a ground surface.

Another aspect of the present invention relates to a method of configuring a wheeled container for use, including providing a wheeled container, the wheeled container including an axle, a first wheel connected to the axle, a container having a bottom portion, and a first slot disposed in the bottom portion of the wheeled container and that receives the axle, the first slot having an inboard end, in which the first wheel is positioned for nesting of the wheeled container in another container, and an outboard end, in which the first wheel is deployed for use, and space therebetween to permit movement of the axle along the first slot. The method also includes placing the wheeled container on a ground surface and thereby causing the axle to move from the inboard position toward the outboard position.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate preferred embodiments of the invention and together with the description, serve to explain principles of the invention.

FIG. 1 is a perspective view of a first embodiment of a container according to the present invention, nested within a like container.

FIG. 2 is a perspective view of the container of FIG. 1.

FIG. 3 is a perspective view of the container of FIG. 1.

FIG. 4 is a plan view of the container of FIG. 1.

FIG. 5 is a side view of the container of FIG. 1.

FIG. 6 is a perspective view of the container of FIG. 1.

FIG. 7 is a perspective view of the container of FIG. 1.

FIG. 8 is a partial side view of the container of FIG. 1, with the wheels and axle removed.

FIG. 9 is a partial side view of the container of FIG. 1, showing the wheels in different configurations.

FIG. 10 is a partial side view a second embodiment of a container according to the present invention.

FIG. 11 is a partial side view of the container of FIG. 1 with a removable structure inserted in a slot.

### DETAILED DESCRIPTION OF THE PREFERRED EMBODIMENTS

Reference will now be made in detail to presently preferred embodiments of the invention, examples of which are illustrated in the accompanying drawings. An effort has been made to use the same reference numbers throughout the drawings to refer to the same or like parts.

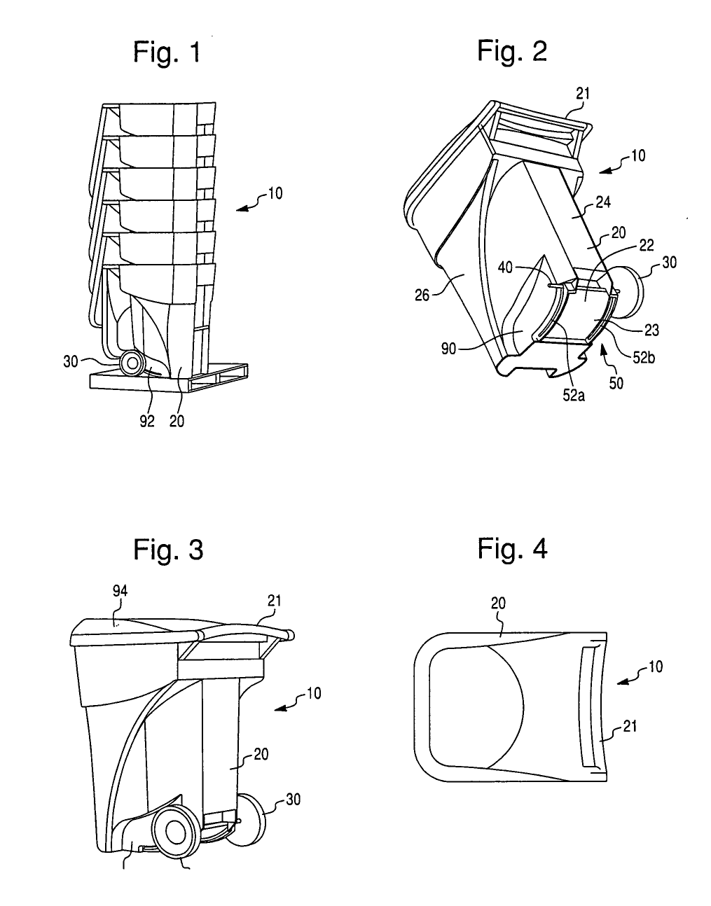

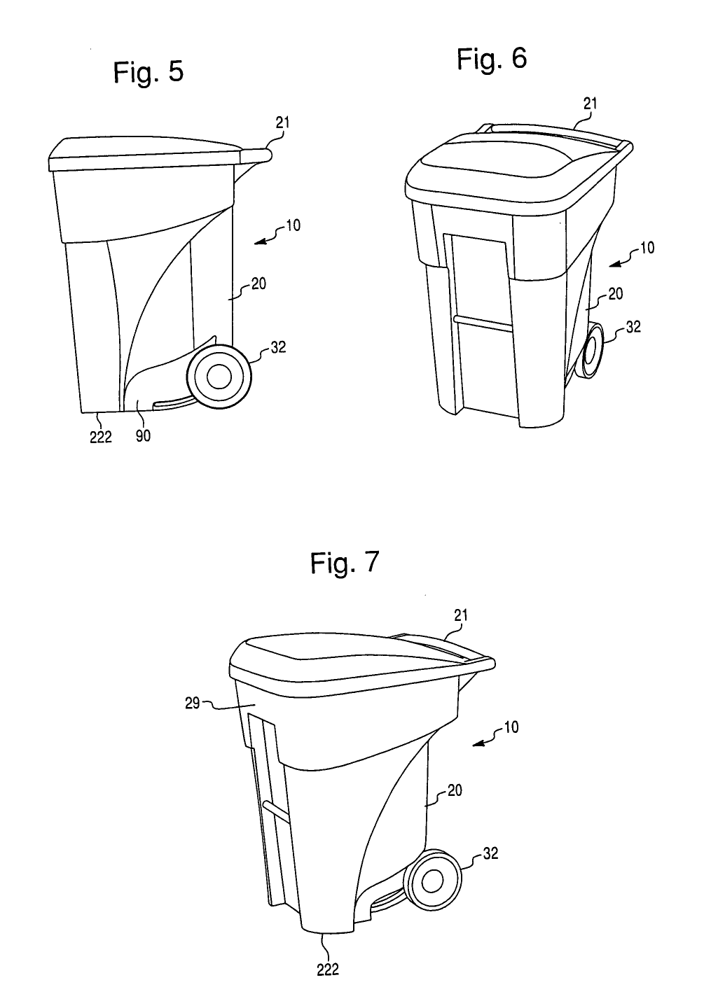

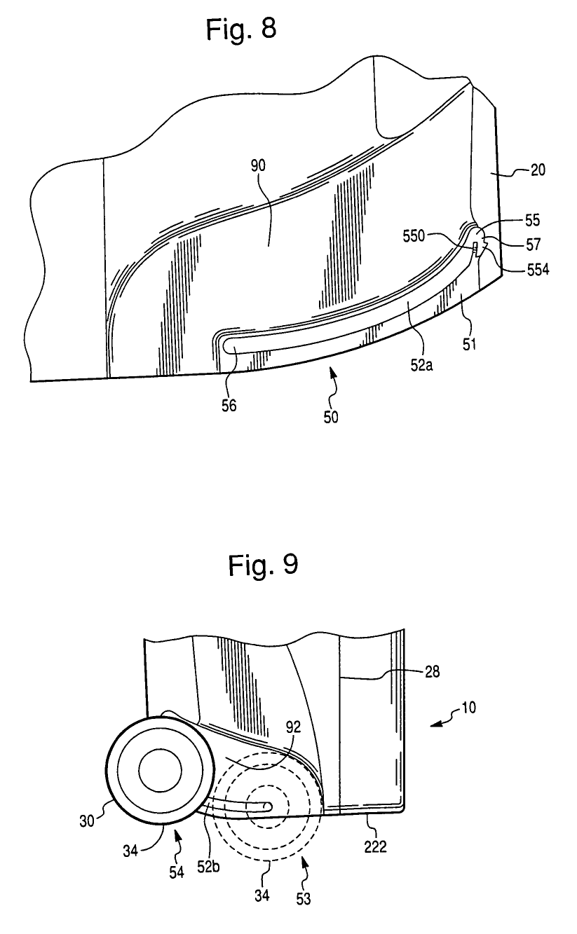

FIGS. 1 to 9 show a first show embodiment of a wheeled container 10 according to the present invention. In this embodiment, the wheeled container 10 includes a container body 20, first and second wheels 30, 32, and an axle 40.

The first and second wheels 30, 32 can be used facilitate transport of the wheeled container 10. Conventional wheels can be used to practice the present invention. In this first preferred embodiment, the first wheel 30 is disposed on one side of the container body 20, and the second wheel 32 is disposed on the other side of the container body 20.

The first and second wheels 30, 32 are connected to the axle 40. The axle 40 can be a conventional metal rod.

The container body 20 is configured to receive, for example, trash. In accordance with this first preferred embodiment, the container body 20 includes a bottom portion 22. The bottom portion 22 is at or near the bottom of the container body 20. Preferably, it is at the very bottom of the container body 20. The container body 20 also preferably includes handle 21, a first container side wall 24, a second container side wall 26, a third container side wall 28, a fourth container side wall 29, and a floor 23. Each of the container side walls 24-29 preferably are generally perpendicular to adjacent side walls, with minor rounded walls connecting the side walls. The combination of the interior surfaces of the side walls 24-29 and an interior surface of the floor 23 form a container cavity (not shown), which can be capped by a conventional moveable lid 94. The lid 94 preferably rotates from a closed position to an open position about parallel to the back side of the container body 20, i.e., an angle of rotation is about 270 degrees. Preferably the container body 20 is configured to permit nesting with other container bodies 20. As can be seen from FIG. 1, the lid 94 can be positioned so that the containers 10 can be nested with the lids 94 in the open position, one lid being supported by another lid.

A connecting structure 50 can be provided to connect the wheels 30, 32 and axle 40 to the container body 20. The connecting structure 50 can include members 51. The members 51 can be integral with the container body 20. For example, the container body 20 and members 51 can be molded from plastic by, e.g., high-pressure injection molding. Other techniques could be used, however, such as a low-pressure roto-molding or blow-molding processes. Instead of forming members 51 integral with the container body 20, the members 51 could be separate members attached to the bottom portion 22 through a secondary operation.

A first slot 52a and a second slot 52b can be provided in the members 51. The first and second slots 52a, 52b are configured to receive the axle 40. The first and second slots 52a, 52b are disposed in the bottom portion 22 of the container body 20. The first and second slots 52a, 52b preferably have generally the same dimensions as one another and are positioned in generally the same orientation.

As shown in FIG. 9, the first and second slots 52a, 52b allow the axle 40, and thus the wheels 30, 32, to move from a nesting position 53, which permits the wheeled container 10 to be nested in another container 10, to an in-use deployed position 54. This in-use deployed position 54 can be configured to maximize the performance and stability of the container 10. The first and second slots 52a, 52b each have an inboard end 56, an outboard end 57, and a space between the inboard end 56 and outboard end 57 to permit movement of the axle 40 along the slot 52a, 52b.

When the axle 40 is positioned at the inboard ends 56, the first and second wheels 30, 32 preferably do not extend beyond a rear portion of the bottom portion 22 of the container body 20. Thus, the wheels 30, 32 are disposed at the nesting position 53.

When the axle 40 is positioned at the outboard ends 57, the first and second wheels 30, 32 preferably extend beyond a rear portion of the bottom portion 22 of the container body 20 and are disposed at the in-use deployed position 54. Even more preferably, when the axle 40 is disposed at the outboard ends 57, the bottoms of the first and second wheels 30, 32 are substantially level with a lowermost portion 222 of the container body 20.

The first and second slots 52a, 52b can be configured to direct the axle 40 toward the outboard end 57 when the wheels 30, 32 are placed on a ground surface. In each of the slots 52a, 52b, the inboard end 56 is preferably disposed below the outboard end 57. More preferably, each of the slots 52a, 52b extends upwardly from the inboard end 56 to the outboard end 57. Even more preferably, each of the slots 52a, 52b has a substantially arcuate shape and a center point of an arc defined by the slot 52a, 52b is disposed above the slot. Preferably the first and second slots 52a, 52b generally follow a curvature of an exterior surface of the floor 23 of the container body 20.

Preferably the wheeled container 10 is configured such that, for each of the wheels 30, 32, the lowest portion 34 extends past the lowest portion 222 of the container body 20 when the axle 40 is located at the inboard end 56 of the slots 52a, 52b, as shown in FIG. 9. The wheels 30, 32 preferably assume this configuration when the container body 20 is held above the ground surface because the axle 40 rolls and/or slides to the lowest portion of the slots 52a, 52b due to gravity (if not retained by retainer 55 described below). When the wheeled container is lowered to the ground surface, the wheels 30, 32 contact the ground surface before the lowest portion 222 of the container body 20 (at least in the case of a level and flat ground surface). Due to the contact of the wheels 30, 32 with the ground surface, a reaction force is generated which imparts an upward force on the wheels 30, 32 (relative to the direction of lowering of the container body 20), which is imparted to the axle 40. This upward force directs the axle 40 towards the outboard end 57 due to the configuration of the slots 52a, 52b.

Each of the slots 52a, 52b can have a retainer 55 adapted to retain the axle 40 at the outboard end 57 and thus hold the wheels 30, 32 and axle 40 in the in-use deployed position 54. The retainers 55 can be configured such that a predetermined external force must be applied to container body 20 to position the axle 40 in the retainers 55.

The retainers 55 each can include a snap-fit member, as shown in FIG. 8. The snap-fit member can include a flexible portion 550 protruding from a wall of the slot 52a, 52b. In a relaxed position, the flexible portion 550 preferably extends into the slot 52a, 52b to form a throat 552 in the slot 52a, 52b. The throat 552 can have a spacing that is less than a diameter of the axle 40 when the flexible portion 550 is in the relaxed position. The flexible portion 550 can move, e.g., via elastic deformation, from the relaxed position to a flexed condition (not shown) in which the flexible portion 550 is received in a recessed portion 554 provided proximate to the flexible portion 550. When the flexible portion 550 is received in the recessed portion 554, the spacing in the throat 552 is widened to a distance equal to or greater than a diameter of the axle 40. The flexible portion 550 can be formed from a material with sufficient elasticity and strength, such as PP or HDPE, to permit elastic flexing of the flexible portion 550.

When the axle 40 passes over the flexible portions 550 of the retainers 55, the flexible portions 550 flex into the recessed portions 554 and out of the way of the axle 40. After the axle 40 has passed the flexible portions 550 and is positioned in the retainers 55, the flexible portions 550 snap back into position and retain the axle 40 in position.

In this first embodiment, the axle 40 can be positioned in the retainer 55 by applying a predetermined external force. For example, the predetermined external force could be a downward force applied to the container body 20 that is sufficient cause the axle 40 to press against the flexible portions 550 and cause the flexible portions 550 to move into the recessed portions 554 and allow the axle 40 to move through the throats 552 to the outboard ends 57 of the slots 52a, 52b.

The retainers 55 preferably permanently retain the axle 40 at the outboard ends 57. In this context, permanently is intended to mean that mechanical unfastening or force of a type or magnitude other than that typically encountered during use is required to remove the axle from the retainers 55. For example, a user could move the flexible portion 552 into the recess 554 with, for example, a dull prying device, and pull the axle 40 through the throat 552, thus releasing the axle 40.

As can be seen from the figures, the container body 20 of the first embodiment is shaped in a manner conducive to nesting containers. For example, container body 20 has wheel wells 90, 92, that permit the wheels 30, 32, to move from the nested position 53 to the in-use deployed position 54. The wheel wells 90, 92 also permit the wheels to be within the footprint of the container 10 in general, and, in particular, within an area formed by the interior cavity of a second similar or same container 10 in which the first container is nested, at the height of the wheels 30, 32 when nested in the second container. To this end, embodiments of the present invention can also have an interior cavity that permits the containers to be nested. In the embodiments of the invention where the wheels 30, 32 extend below the lowermost point 222 of the container 10 when in the nested position, the cavity of the container 10 would have sufficient clearance for the wheels 30, 32.

Use of the container 10 will be briefly described. Lifting the container body 20 causes the wheels 30, 32 and axle 40 to move to the nested position 53 so that the container 10 can be placed in a nested stack of two or more containers, as shown in FIG. 1, and packaged for shipping.

After being received at a final destination, removed from the nested stack, and placed on a ground surface, the wheels 30, 32 and axle 40 of an exemplary embodiment of the container 10 can be moved to the in-use deployed position 54. In particular, when the container 10 is placed on the ground, the wheels 30, 32 and axle 40 will slide in the outboard direction along slots 52a, 52b, due to the configuration of the slots 52a, 52b, until the axle 40 contacts the flexible portion 550 of the retainer 55. A force can be applied to the container body 20 to cause the axle 40 to pass through the throat of the retainers 55 and position the wheels 30, 32 into the in-use deployed position 54.

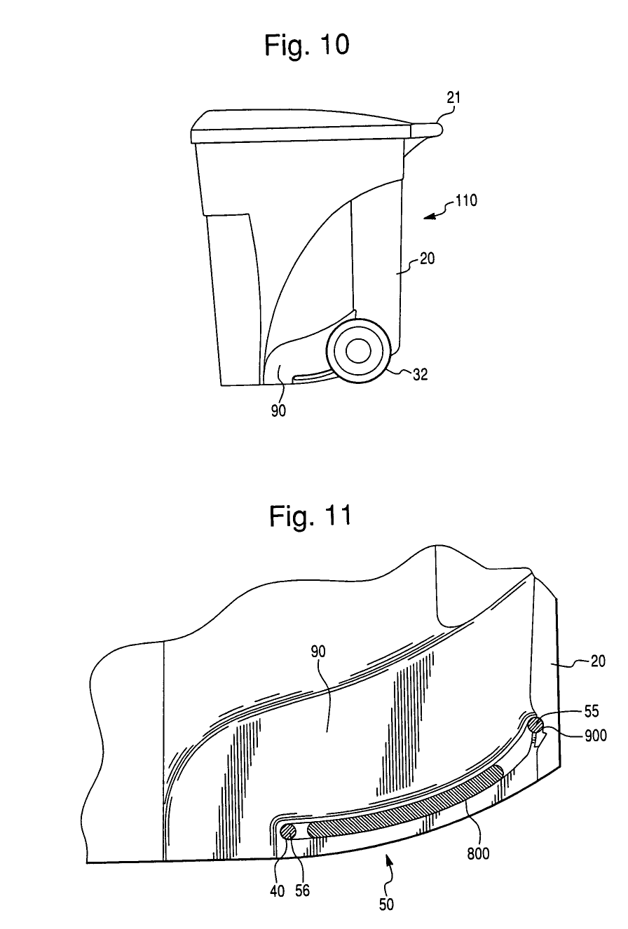

FIG. 10 shows a second preferred embodiment of a wheeled container 110 according to the present invention. This embodiment is similar in many respects to the first embodiment. In this second embodiment, however, the wheels 30, 32 of the wheeled container 110 do not extend beyond a rear portion of the bottom portion 22 of the container 110 when the axle 40 is disposed at the outboard end 57 of the slots 52a, 52b.

Embodiments of the present invention can use a removable structure 800 or 900, as shown in FIG. 11, to temporarily prevent and/or limit the movement of the axle 40 along slots 52a, 52b. The removable structure 800 could be a piece of cardboard that fits into the space between the inboard end 56 and the outboard end 57 of one or both of the slots 52a, 52b. Alternatively, the removable structure 900 could be a piece of cardboard that fits into the outboard end 57 of one or both of the slots 52a, 52b. The removable structure 800 or 900 prevents the axle 40 from moving along the slots and/or from entering the outboard end 57 of the slots 52a, 52b. Thus, the removable structure 800 or 900 can prevent the axle 40 from being locked into retainers 55.

The removable structure 800 or 900 can be advantageous, for example, to prevent the axle 40 from being prematurely locked in the retainers 55. For example, in a retail environment a customer may inadvertently lock the axle 40 in the retainers 55 while still in the store. As it may be undesirable for the axle 40 to be locked in position before the wheeled container 10 is purchased, the removable structure 800 or 900 can be used to prevent this from occurring. The removable structure 800 or 900 is placed in the slot(s) 52a, 52b before shipping. A customer would have to remove the structure 800 or 900 to move the axle 40 towards the retainers 55 and/or retain the axle 40 in the retainers 55.

The wheeled container 10 of the present invention is particularly advantageous because it can be configured such that downward force on the handle 21 on the container body 20 will cause the wheels 30, 32 and axle 40 to move to the in-use deployed position 54. In other words, the present invention can be configured so as to use motions inherent in the un-nesting process to move the wheels 30, 32 and axle 40, thus requiring little extra effort by the user. As the bottom of the container body 20 is placed on the ground, it is believed that the weight of the container body 20 and the angle of the slots 52a, 52b relative to the floor, push the axle 40 outboard toward the in-use position deployed position 54. In the exemplary embodiment, the only purposeful action required by the user is to supply a final downward or substantially downward pressure on the handle 21, to firmly lock the axle 40 in the in-use position. The user does not need to reach down and move the axle 40 by hand. However, in an embodiment utilizing the removable structure 800 or 900, as discussed above, the user might first have to reach down or take some other action to remove the removable structure 800 or 900 from the slots 52a, 52b.

In a retail environment, this operation can be done quickly and easily by the consumer. In some embodiments, only a small amount of extra effort compared to the effort required for removing a nested container, and with little written or graphic instructions, would be needed. Of course, in the embodiment utilizing the removable structure 800 or 900, the consumer would need to remove the removable structure.

An example of a commercial situation would be a municipal waste hauler (garbage collector) receiving a shipment of containers 10. The containers 10 could be delivered to each residence or business, and the above described process would be performed by an employee of the waste hauler, on-site as each container was un-nested and removed from the delivery truck.

Thus, some embodiments of the present invention provide a container 10 that (a) can be nested, (b) has parts that are connected so they will not be lost during shipping, and (c) after being un-nested has wheels that quickly and easily move to a position of maximum stability, comparable to the stability of containers that are shipped unassembled.

The present invention can reduce costs often incurred by users of containers that are shipped unassembled. For example, labor costs can be reduced because the wheels can be quickly moved from the nested position 53 to the in-use position deployed 54. As another example, costs associated with lost parts can be reduced because the wheels 30, 32 and axle 40 are connected to the container body 10 during shipping.

Other embodiments of the invention will be apparent to those skilled in the art from consideration of the specification and practice of the invention disclosed herein. It is intended that the specification and examples be considered as exemplary only.

What is claimed is:

1. A wheeled container comprising:
an axle;
a first wheel connected to the axle;
a container body having a bottom portion; and
a first slot disposed in the bottom portion of the container body and that receives the axle, the first slot having an inboard end, in which the first wheel is positioned for nesting of the wheeled container in another container, and an outboard end, in which the first wheel is deployed for use, and space therebetween to permit movement of the axle along the first slot, the first slot being configured to direct the axle toward the outboard end when the first wheel is placed on a ground surface.

2. The wheeled container of claim 1, wherein the inboard end of the first slot is disposed below the outboard end of the first slot.

3. The wheeled container of claim 2, wherein the first slot extends upwardly from the inboard end to the outboard end.

4. The wheeled container of claim 2, wherein the first slot has a substantially arcuate shape.

5. The wheeled container of claim 4, wherein a center point of an arc defined by the first slot is disposed above the first slot.

6. The wheeled container of claim 1, wherein the first slot further comprises a retainer adapted to retain the axle at the outboard end.

7. The wheeled container of claim 6, wherein a predetermined external force must be applied to container body to position the axle in the retainer.

8. The wheeled container of claim 6, wherein the retainer includes a snap-fit member.

9. The wheeled container of claim 8, wherein the snap-fit member includes a flexible portion protruding from a wall of the first slot to form a throat in the first slot, the throat having a spacing that is less than a diameter of the axle when the flexible portion is in a relaxed position.

10. The wheeled container of claim 9, wherein the slot has a recessed portion proximate to the flexible portion, and wherein the recessed portion is adapted to receive the flexible portion when the flexible portion is in a flexed condition to widen the spacing in the throat to a distance equal to or greater than a diameter of the axle.

11. The wheeled container of claim 1, further comprising a second slot disposed in the bottom portion of the container body and that receives the axle, wherein the second slot has substantially the same configuration as the first slot.

12. The wheeled container of claim 1, wherein, when the axle is disposed at the inboard end, the first wheel does not extend beyond a rear portion of the bottom portion of the container body.

13. The wheeled container of claim 1, wherein, when the axle is disposed at the outboard end, the first wheel extends beyond a rear portion of the bottom portion of the container body.

14. The wheeled container of claim 1, wherein, when the axle is disposed at the outboard end, a bottom of the first wheel is substantially level with a bottom surface of the container body.

15. The wheeled container of claim 1, further comprising a removable structure extending through the first slot between the axle and the outboard end of the first slot to prevent the axle from moving to the outboard end when the first wheel is placed on the ground surface.

16. The wheeled container of claim 6, wherein a removable structure extends through the retainer to prevent the axle from being retained at the outboard end.

17. A method of configuring a wheeled container for use, comprising:
providing a wheeled container, the wheeled container including:
an axle;
a first wheel connected to the axle;
a container body having a bottom portion; and
a first slot disposed in the bottom portion of the container body and that receives the axle, the first slot having an inboard end, in which the first wheel is positioned for nesting of the wheeled container in another container, and an outboard end, in which the first wheel is deployed for use, and space therebetween to permit movement of the axle along the first slot; and
placing the wheeled container on a ground surface and thereby causing the axle to move from the inboard position toward the outboard position.

18. The method of claim 17, wherein the first slot further comprises a retainer adapted to retain the axle at the outboard end, and further comprising applying an external force to the container body to position the axle in the retainer.
